(19) United States
(12) Patent Application Publication
(10) Pub. No.: US 2018/0148549 A1
(43) Pub. Date: May 31, 2018

(54) GOLF BALL

(71) Applicant: Bridgestone Sports Co., Ltd., Tokyo (JP)

(72) Inventor: Tsuyoshi NAKAJIMA, Chichibushi (JP)

(73) Assignee: Bridgestone Sports Co., Ltd., Tokyo (JP)

(21) Appl. No.: 15/809,494

(22) Filed: Nov. 10, 2017

(30) Foreign Application Priority Data
Nov. 29, 2016 (JP) 2016-231567

(51) Int. Cl. C08J 3/24

(52) U.S. Cl. CPC C08J 3/24; C08J 2309/00

(57) ABSTRACT

A golf ball contains, as a structural element therein, a molded and crosslinked material obtained from a rubber composition which includes: (a) a base rubber (b) an α,β-unsaturated carboxylic acid and/or a metal salt thereof, (c) a crosslinking initiator, and (d) a metal carboxylate in which the carboxylic acid bonded to metal is of two or more different types and at least one of the carboxylic acids has 8 or more carbon atoms. The rubber composition has an improved processability in kneading and other operations, and the decrease in the initial velocity of the ball core resulting from the inclusion of additives can be held to a minimum.

### CROSS-REFERENCE TO RELATED APPLICATION

This non-provisional application claims priority under 35 U.S.C. § 119(a) on Patent Application No. 2016-231567 filed in Japan on Nov. 29, 2016, the entire contents of which are hereby incorporated by reference.

### TECHNICAL FIELD

This invention relates to a golf ball such as a two-piece or three-piece golf ball which includes, as a core, cover or other structural element of the ball, a molded rubber material.

### BACKGROUND ART

Because the core of a golf ball accounts for a high proportion of the overall ball, the core material exerts a large influence on the ball quality. Hence, there is a desire to obtain high-quality core materials that increase the core hardness or target a desired hardness profile for the purpose of increasing resilience, particularly molded rubber materials for high-rebound golf balls.

In order to obtain a high-rebound golf ball, it is necessary to select the base rubber for the rubber composition and to suitably select the types and contents of, for example, crosslinking agents (crosslinking initiators and co-crosslinking agents) for the base rubber. Of these, metal salts of unsaturated carboxylic acids, such as zinc acrylate, are known to act as co-crosslinking agents on the main chain of the base rubber (especially polybutadiene) under the effect of organic peroxides such as dicumyl peroxide. However, one problem is that, during intensive mixing (kneading) of the rubber composition, the zinc acrylate sticks to surfaces of the mixing apparatus and the mixing operation becomes difficult to carry out. Another problem is that agglomerates tend to form during rubber compounding, as a result of which the dispersibility worsens, making it impossible to obtain a desired hardness and resilience for the molded rubber material (core) in keeping with the content of zinc acrylate.

To ameliorate such problems, JP-A S59-141961 and JP-A S60-92781 describe art which suppresses zinc acrylate adhesion to the inner walls of the apparatus during rubber mixing by using zinc acrylate that has been surface-coated with a higher fatty acid and a metal salt thereof such as stearic acid and its zinc salt.

However, such art has the drawback that the higher fatty acid and its metal salt end up lowering the initial velocity of the core. Hence, there exists a desire for an additive which can increase the processability in kneading and other operations, and the inclusion of which does not tend to decrease the initial velocity of the core.

### SUMMARY OF THE INVENTION

It is therefore an object of the present invention to provide a golf ball in which has been included an additive that is capable of improving processability while holding to a minimum any decrease in initial velocity.

As a result of extensive investigations, the inventor has discovered that, by including a metal carboxylate in which the carboxylic acid bonded to metal is of two or more different types and at least one of the carboxylic acids has 8 or more carbon atoms as a new ingredient within a rubber composition containing as the essential ingredients a base rubber, an α,β-unsaturated carboxylic acid and/or a metal salt thereof and a crosslinking initiator, and molding the rubber composition under applied heat, the productivity (processability) can be improved and the decrease in the resilience (initial velocity) of the resulting core can be held to a minimum.

Accordingly, the invention provides a golf ball containing, as a structural element therein, a molded and crosslinked material obtained from a rubber composition which includes: (a) a base rubber, (b) an α,β-unsaturated carboxylic acid and/or a metal salt thereof (c) a crosslinking initiator, and (d) a metal carboxylate in which the carboxylic acid bonded to metal is of two or more different types and at least one of the carboxylic acids has 8 or more carbon atoms.

In a preferred embodiment of the golf ball of the invention, component (b) is a metal salt of an α,β-unsaturated carboxylic acid (sometimes referred to below as an “unsaturated metal carboxylate”), the metal salt typically being a zinc salt.

In another preferred embodiment, the content of component (b) is from 5 to 50 parts by weight per 100 parts by weight of component (a).

In yet another preferred embodiment, at least one of the carboxylic acids bonded to metal in the metal carboxylate serving as component (d) is an unsaturated carboxylic acid, especially an α,β-unsaturated carboxylic acid having from 3 to 8 carbon atoms.

In a further preferred embodiment, the metal species in the metal carboxylate of component (d) is selected from the group consisting of zinc, calcium, magnesium, copper, aluminum, iron and zirconium.

In a yet further preferred embodiment, the content of component (d) is from 1 to 25 parts by weight per 100 parts by weight of component (a).

In a still further preferred embodiment, component (d) has a weight ratio with respect to component (b) of from 4 to 50 wt %.

### Advantageous Effects of the Invention

The rubber composition used in the golf ball of the invention has an improved processability during production, yet holds to a minimum any decrease in the initial velocity of the resulting ball core.

### DESCRIPTION OF THE PREFERRED EMBODIMENTS

The objects, features and advantages of the invention will become more apparent from the following detailed description.

This invention relates to a golf ball containing, as a structural element therein, a molded and crosslinked material obtained from a rubber composition which includes: (a) a base rubber, (b) an α,β-unsaturated carboxylic acid and/or a metal salt thereof, (c) a crosslinking initiator, and (d) a metal carboxylate in which the carboxylic acid bonded to metal is of two or more different types and at least one of the carboxylic acids has 8 or more carbon atoms. These components (a) to (d) are described below.

### (a) Base Rubber

It is suitable to use polybutadiene as the base rubber serving as component (a). The polybutadiene has a cis-1,4 bond content of at least 60% (here and below, “%” stands for percent by weight), preferably at least 80%, more preferably at least 90%, and most preferably at least 95%. When the cis-1,4 bond content is too low, the resilience decreases. The content of 1,2-vinyl bonds is preferably not more than 2%, more preferably not more than 1.7%, and even more preferably not more than 1.5%.

The polybutadiene has a Mooney viscosity (ML₁₊₄ (100° C.) of preferably at least 30, and more preferably at least 35, with the upper limit being preferably not more than 100, and more preferably not more than 90.

Illustrative examples of the polybutadiene include the following cis-1,4-polybutadiene rubbers available from JSR Corporation: high-cis BR01, BR11, BR02, BR02L, BR02LL, BR730 and BR51.

To obtain a molded and crosslinked rubber composition having a good resilience, the polybutadiene is preferably one synthesized using a rare-earth catalyst or a group VIII metal compound catalyst.

The rare-earth catalyst is not particularly limited, although one that employs a lanthanum series rare-earth compound may be suitably used. Where necessary, an organoaluminum compound, an alumoxane, a halogen-containing compound and a Lewis base may be optionally used in combination with the lanthanum series rare-earth compound. Suitable use may be made of, as the various foregoing compounds, those mentioned in JP-A H11-35633, JP-A H11-164912 and JP-A 2002-293996.

Of the above rare-earth catalysts, catalysts that use the lanthanum series rare-earth elements neodymium, samarium or gadolinium are suitable, with the use of a neodymium catalyst in particular being recommended. In such cases, a polybutadiene rubber having a high cis-1,4 bond content and a low 1,2-vinyl bond content can be obtained at an excellent polymerization activity.

The polybutadiene accounts for a proportion of the overall rubber composition which is preferably at least 40 wt %, more preferably at least 60 wt %, even more preferably at least 80 wt %, and most preferably at least 90 wt %. The polybutadiene may account for 100 wt % of the base rubber, although it preferably accounts for not more than 98 wt %, and more preferably not more than 95 wt %.

The base rubber may include rubber components other than the above polybutadiene within a range that does not detract from the advantageous effects of the invention. Examples of such rubber components other than the foregoing polybutadiene include other polybutadienes, and diene rubbers other than polybutadiene, such as styrene-butadiene rubber, natural rubber, isoprene rubber and ethylene-propylene-diene rubber.

### (b) α,β-Unsaturated Carboxylic Acid or Metal Salt Thereof

An α,β-Unsaturated carboxylic acid (e.g., acrylic acid, methacrylic acid) and/or a metal salt thereof are included in the rubber composition. Examples of the metal include zinc, sodium, potassium, magnesium, lithium and calcium. Copper is not included. α,β-Unsaturated carboxylic acids having from 3 to 8 carbon atoms are especially preferred as the α,β-unsaturated carboxylic acid. The α,β-unsaturated carboxylic acid is preferably selected from the group consisting of acrylic acid, methacrylic acid, ethacrylic acid, itaconic acid, maleic acid and fumaric acid. Alternatively, a metal salt of an α,β-unsaturated carboxylic acid may be suitably used. It is especially preferable for the metal salt to be a zinc salt.

The content of component (b), although not particularly limited, is preferably at least 5 parts by weight, and more preferably at least 15 parts by weight, but preferably not more than 50 parts by weight, and more preferably not more than 45 parts by weight, per 100 parts by weight of the base rubber.

### (c) Crosslinking Initiator

An organic peroxide may be suitably used as the crosslinking initiator in this invention. Illustrative examples of organic peroxides include 1,1-di(t-butylperoxy)cyclohexane, 1,1-bis-t-butylperoxy-3,3,5-trimethylcyclohexane, dicumyl peroxide, di(t-butylperoxy)-m-diisopropylbenzene and 2,5-dimethyl-2,5-di-t-butylperoxyhexane. These organic peroxides may be of one type used alone, or two or more types may be used in combination.

The content of the organic peroxide, although not particularly limited, may be set to at least 0.1 part by weight, and preferably at least 0.3 part by weight, per 100 parts by weight of the base rubber. The upper limit may be set to not more than 5 parts by weight, and preferably not more than 2 parts by weight.

(d) Metal carboxylate

Component (d) is a metal carboxylate in which the carboxylic acid bonded to metal is of two or more different types and at least one of the carboxylic acids has 8 or more carbon atoms. As used herein, “bond” refers to a bond between a metal and a carboxylic acid; the number of bonds varies depending on the metal species. Specifically, sodium and potassium have one bonding site, zinc and calcium have two, and iron and aluminum have three. Because the number of bonding sites on the metal must be two or more in order for the metal carboxylate to be able to serve as component (d) in this invention, the metal species is limited to those have two or more bonding sites. In the case of a zinc salt, for example, letting one of the two bonding sites on zinc be a carboxylic acid A having 8 or more carbon atoms, the second carboxylic acid must be one other than carboxylic acid A. Such carboxylic acids are denoted herein with names having the prefix “mono” to distinguish them from metal salts with two bonds (disalts) in which the carboxylic acids bonded to the metal are both the same, such as zinc stearate. Illustrative examples of component (d) include compounds of structural formula (1) or (2) below.

R¹-M¹-R² (1)

In formula (1), R¹ and R² are each different carboxylic acids, with at least one of R¹ and R² having 8 or more carbon atoms. M¹ represents a divalent metal atom.

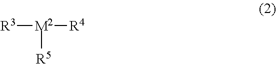

In formula (2), R³ to R⁵ are two or more different carboxylic acids, with at least one of R³ to R⁵ having 8 or more carbon atoms. M² represents a trivalent metal atom.

By having component (d) be two or more different carboxylic acids bonded to a metal, with at least one of the carboxylic acids having 8 or more carbon atoms, the processability can be improved and the decrease in the initial velocity of the core owing to the addition of component (d) can be held to a minimum.

In component (d), it is preferable for at least one of the carboxylic acids bonded to the metal to be an unsaturated carboxylic acid, and more preferable for the unsaturated carboxylic acid to be an α,β-unsaturated carboxylic acid having from 3 to 8 carbon atoms. Also, it is especially preferable for the metal species in the metal carboxylate of component (d) to be one selected from the group consisting of zinc, calcium, magnesium, copper, aluminum, iron and zirconium.

Illustrative examples of component (d) include zinc monostearate monopalmitate, zinc monostearate monomyristate, zinc monostearate monolaurate, zinc monopalmitate monomyristate, zinc monopalmitate monolaurate, zinc monostearate monoacrylate, zinc monostearate monomethacrylate, zinc monostearate monomaleate, zinc monostearate monofumarate, zinc monopalmitate monoacrylate, zinc monopalmitate monomethacrylate, zinc monopalmitate monomaleate, zinc monopalmitate monofumarate, zinc monomyristate monoacrylate, zinc monomyristate monomethacrylate, zinc monomyristate monomaleate, zinc monomyristate monofumarate, zinc monolaurate monoacrylate, zinc monolaurate monomethacrylate, zinc monolaurate monomaleate and zinc monolaurate monofumarate. Zinc monostearate monoacrylate is preferred. Cases in which the carboxylic acids bonded to the metal are the same, such as zinc stearate, do not fall within the scope of this invention.

The form of component (d) in the rubber composition is not particularly limited. For example, it may be present in a form that is mixed and dispersed, within the rubber composition, together with the α,β-unsaturated carboxylic acid or a metal salt thereof serving as component (b). Another form is one in which the surface of component (b), especially a metal salt of an α,β-unsaturated carboxylic acid such as zinc acrylate, is coated with component (d). That is, component (d) may be included in the rubber composition as a coating layer on component (b).

Component (d) can be easily obtained by reacting a metal compound in the presence of a plurality of carboxylic acids. Specifically, in the case of zinc monostearate monoacrylate, this can be obtained by dissolving stearate acid and acrylic acid in a reaction solution and mixing therein zinc oxide suspended in a solvent so as to induce the reaction. Alternatively, it can be obtained by adding stearic acid and acrylic acid to a solution obtained by suspending zinc oxide in a solvent.

The content of component (d) per 100 parts by weight of the base rubber is preferably from 0.1 to 50 parts by weight, and more preferably from 1 to 25 parts by weight. The weight ratio of component (d) to component (b) is preferably from 1 to 99 wt %, and more preferably from 4 to 50 wt %. At a component (d) content lower than this range, a sufficient processability improving effect may not be obtainable. On the other hand, at a component (d) content higher than this range, the initial velocity of the core may decrease more than necessary.

In the practice of this invention, various inorganic compounds other than the ingredients mentioned above may be suitably included as additional rubber compounding ingredients.

For example, an inorganic filler may be typically compounded with the base rubber. This has the role primarily of adjusting the rubber weight. Illustrative examples of such inorganic fillers include zinc oxide, calcium carbonate, calcium oxide, magnesium oxide, barium sulfate and silica. The use of a metal oxide such as zinc oxide, calcium oxide or magnesium oxide is especially preferred.

As for other optional ingredients in the rubber composition, an organosulfur compound may be included for the purpose of improving the resilience of the molded and crosslinked rubber material. Such organosulfur compounds are exemplified by thiophenols, thionaphthols, halogenated thiophenols and metals salts thereof. Specific examples include pentachlorothiophenol, pentafluorothiophenol, pentabromothiophenol, p-chlorothiophenol and metal salts thereof, especially zinc salts. In this case, the content of the organosulfur compound is preferably at least 0.001 part by weight and not more than 5 parts by weight, per 100 parts by weight of the base rubber.

To further increase the cross-sectional hardness distribution (difference between core surface hardness and core center hardness) of the molded and crosslinked rubber material, it is preferable to add, for example, elemental sulfur or an inorganic sulfur compound. The content of elemental sulfur or inorganic sulfur compound in this case is preferably from 0.01 to 5 parts by weight.

Known processing aids may be added to improve the processability of the rubber composition. Other materials that may be added to the rubber composition include ground-up golf ball cores, ground-up golf ball cover stock, ground-up used golf balls, and also ground-up rubber and plastic waste generated from golf ball manufacturing operations.

Where necessary, an antioxidant may also be included. For example, a compound such as 2,2′-methylenebis(4-methyl-6-tert-butylphenol) may be used. The amount of antioxidant included per 100 parts by weight of the base rubber is preferably at least 0.05 part by weight, and more preferably at least 0.1 part by weight. The upper limit is preferably not more than 3 parts by weight. Illustrative examples include Nocrac NS-6, Nocrac NS-5 and Nocrac NS-30 from Ouchi Shinko Chemical Industry Co., Ltd.

Aside from the above rubber composition, a silicone powder may also be suitably included. In such a case, there are no particular limitations on the particle size of the silicone powder and the functional groups that modify the silicone powder. Moreover, aside from the above rubber composition, various types of thermoplastic resins may also be suitably included.

A molded and crosslinked rubber material can be obtained by processing the above rubber composition using methods similar to those used for conventional golf ball compositions. An example of such a method is that of working the rubber composition with a kneading apparatus such as a roll mill, kneader or Banbury mixer, and then using a mold so as to mold the worked composition under applied heat and pressure. The crosslinking conditions are not particularly limited as to temperature and time, although it is preferable to carry out crosslinking for a period of 10 to 40 minutes at between 100° C. and 200° C.

The golf ball of the invention includes, as a structural element therein, the above molded and crosslinked rubber material. The ball may take various forms, including, without particular limitation, one-piece golf balls in which the molded and crosslinked rubber material is used directly as the golf ball, two-piece solid golf balls in which the molded and crosslinked rubber material serves as the core and a cover is formed on the surface thereof, multi-piece solid golf balls of three or more pieces in which the molded and crosslinked rubber material serves as the core and two or more covers are formed thereon, and wound golf balls in which the above molded and crosslinked rubber material is used as the center core. In particular, to take advantage of the characteristics of the molded and crosslinked material and to confer the manufactured golf ball with low spin properties on shots with a driver, two-piece solid golf balls and multi-piece solid golf balls which use the molded and crosslinked rubber material as the core are recommended as suitable forms of use.

The core has a diameter which, although not particularly limited, is preferably at least 30 mm, and more preferably at least 35 mm, with the upper limit being preferably not more than 41 mm, and more preferably not more than 40 mm. At a core diameter outside of this range, the initial velocity of the ball may decrease and suitable spin properties may not be obtainable.

The core has a deflection under a given loading, i.e., a deflection when compressed under a final load of 1,275 N (130 kgf) from an initial load state of 98 N (10 kg), which has a lower limit of preferably at least 2.0 mm, more preferably at least 2.5 mm, and even more preferably at least 2.8 mm, and an upper limit of preferably not more than 5.0 mm, more preferably not more than 4.7 mm, and even more preferably not more than 4.5 mm. When this core deflection is too small, the feel of the ball at impact may markedly worsen or the spin rate may rise excessively, as a result of which the desired distance may not be achieved. On the other hand, when this deflection is too large, a good initial velocity may not be obtained or the durability of the ball may markedly worsen.

The core has an initial velocity which, although not particularly limited, is preferably at least 77.0 m/s, and more preferably at least 77.3 m/s. Measurement of the core initial velocity is carried out using the measurement apparatus and measurement conditions described subsequently in the “Examples” section of the Specification.

As noted above, the rubber composition is well-suited for use as a golf ball core. Moreover, the golf ball of the invention preferably has a structure that includes a core and a cover of at least one layer. The core may be formed as a single layer or as a plurality of two or more layers. In this invention, “cover” is a general appellation for the layer (or layers) formed outside of the core, and consists of at least one layer. In cases where the cover consists of a plurality of layers, in addition to the outermost layer of the cover, an intermediate layer situated between the outermost layer and the core is also included. Accordingly, the cover may be a two-layer cover consisting of, in order from the inside, an intermediate layer and an outermost layer. In addition, an envelope layer may be provided between the core and the intermediate layer, in which case the cover may be a three-layer cover having, in order from the inside, an envelope layer, an intermediate layer and an outermost layer. Numerous dimples are generally formed on the outer surface of the outermost layer of the cover.

The materials making up the respective cover layers are not particularly limited, although various thermoplastic resin materials may be suitably used as the intermediate layer material, the use of a high-resilience resin material as the intermediate layer material being especially preferred. For example, the use of an ionomer resin material is preferred.

Commercial products may be used as this resin. Illustrative examples include sodium-neutralized ionomer resins such as Himilan® 1605, Himilan® 1601 and AM 7318 (all products of DuPont-Mitsui Polychemicals Co., Ltd.) and Surlyn@ 8120 (E.I. DuPont de Nemours & Co.); zinc-neutralized ionomer resins such as Himilan® 1557, Himilan® 1706 and AM 7317 (all products of DuPont-Mitsui Polychemicals Co., Ltd.); and the products available from E.I. DuPont de Nemours & Co. under the trade names HPF 1000, HPF 2000 and HPF AD1027, as well as the experimental material HPF SEP1264-3. These may be used singly or two or more may be used in combination.

Exemplary materials for the cover outermost layer include not only the above-mentioned ionomer resins, but also, from the standpoint of controllability and scuff resistance, polyurethanes. In particular, when using polyurethane as the outermost layer material, a thermoplastic polyurethane elastomer may be employed. A commercial product may be suitably used as this thermoplastic polyurethane elastomer. Illustrative examples include products available from DIC Covestro Polymer Ltd. under the trade name PANDEX and products available from Dainichiseika Color & Chemicals Mfg. Co., Ltd. under the trade name RESAMINE.

From the standpoint of aerodynamic performance, the golf ball of the invention to generally is provided with numerous dimples on the surface of the outermost layer. Also, a paint film layer is generally formed on the cover surface for the sake of aesthetics, durability and the like. The paint that forms this paint film layer is preferably a two-part curable urethane paint. Such two-part curable urethane paints include a base resin composed primarily of a polyol resin and a curing agent composed primarily of polyisocyanate.

The golf ball of the invention has a diameter of not less than 42 mm, preferably not less than 42.3 mm, and more preferably not less than 42.6 mm. The ball diameter is not more than 44 mm, preferably not more than 43.8 mm, even more preferably not more than 43.5 mm, and still more preferably not more than 43 mm. The golf ball weight is preferably not less than 44.5 g, more preferably not less than 44.7 g, even more preferably not less than 45.1 mm, and most preferably not less than 45.2 g. The ball weight is preferably not more than 47.0 g, more preferably not more than 46.5 g, and even more preferably not more than 46.0 g.

### EXAMPLES

Working Examples and Comparative Examples are provided below to illustrate the invention, and are not intended to limit the scope thereof.

### Working Examples 1 to 7, Comparative Examples 1 to 7

Rubber compositions were prepared by blending the ingredients shown in Table 1 below. Cores having a diameter of 38.55 mm were produced by kneading the rubber compositions in the respective Examples, carrying out 15 minutes of vulcanization at 157° C., and abrading the surfaces of the vulcanized cores.

TABLE 1

| | | | Working Example | | | | | | |
|---|---|---|---|---|---|---|---|---|---|
| | | | 1 | 2 | 3 | 4 | 5 | 6 | 7 |
| Rubber | Polybutadiene rubber | | 100 | 100 | 100 | 100 | 100 | 100 | 100 |
| composition | Zinc oxide | | 4 | 4 | 4 | 4 | 4 | 4 | 4 |
| (pbw) | Barium sulfate | | 8.8 | 8.8 | 8.8 | 8.8 | 8.8 | 8.8 | 8.8 |
| | Antioxidant | | 0.1 | 0.1 | 0.1 | 0.1 | 0.1 | 0.1 | 0.1 |
| | Zinc salt of pentachlorothiophenol | | | | 1 | | | 1 | 1 |
| | Unsaturated metal carboxylate | | 29 | 26 | 29 | 29 | 29 | 29 | 29 |
| | Metal carboxylate 1 | | 4.4 | 3.9 | 4.4 | 1.4 | 14.5 | 1.4 | 14.5 |
| | Metal carboxylate 2 | | | | | | | | |
| | Organic Peroxide 1 | | 0.6 | 0.6 | 0.6 | 0.6 | 0.6 | 0.6 | 0.6 |
| | Organic Peroxide 2 | | 0.6 | 0.6 | 0.6 | 0.6 | 0.6 | 0.6 | 0.6 |
| Core | Deflection/Deformation (mm) | | 3.11 | 3.47 | 3.60 | 3.12 | 3.02 | 3.60 | 3.45 |
| properties | Initial velocity (m/s) | | 77.53 | 77.19 | 77.97 | 77.52 | 77.35 | 77.96 | 77.83 |
| | Hardness | Center hardness | 62.3 | 61.5 | 61.1 | 62.0 | 60.8 | 61.0 | 60.0 |
| | distribution | Surface hardness | 78.0 | 76.9 | 76.4 | 78.2 | 77.0 | 76.1 | 75.5 |
| | (JIS-C) | Surface hardness − | 15.7 | 15.4 | 15.3 | 16.2 | 16.2 | 15.1 | 15.5 |
| | | Center hardness | | | | | | | |
| Productivity | | | good | good | good | good | Exc | good | Exc |
| | | | Comparative Example | | | | | | |
| | | | 1 | 2 | 3 | 4 | 5 | 6 | 7 |
| Rubber | Polybutadiene rubber | | 100 | 100 | 100 | 100 | 100 | 100 | 100 |
| composition | Zinc oxide | | 4 | 4 | 4 | 4 | 4 | 4 | 4 |
| (pbw) | Barium sulfate | | 8.8 | 8.8 | 8.8 | 8.8 | 8.8 | 8.8 | 8.8 |
| | Antioxidant | | 0.1 | 0.1 | 0.1 | 0.1 | 0.1 | 0.1 | 0.1 |
| | Zinc salt of pentachlorothiophenol | | | | | | 1 | | 1 |
| | Unsaturated metal carboxylate | | 29 | 26 | 29 | 26 | 29 | 29 | 29 |
| | Metal carboxylate 1 | | | | | | | | |
| | Metal carboxylate 2 | | | | 4.4 | 3.9 | 4.4 | 14.5 | 14.5 |
| | Organic Peroxide 1 | | 0.6 | 0.6 | 0.6 | 0.6 | 0.6 | 0.6 | 0.6 |
| | Organic Peroxide 2 | | 0.6 | 0.6 | 0.6 | 0.6 | 0.6 | 0.6 | 0.6 |
| Core | Deflection/Deformation (mm) | | 4.51 | 4.88 | 3.11 | 3.47 | 3.60 | 3.02 | 3.45 |
| properties | Initial velocity (m/s) | | 76.67 | 76.43 | 77.48 | 77.15 | 77.92 | 77.08 | 77.58 |
| | Hardness | Center hardness | 56.8 | 53.7 | 60.7 | 59.9 | 58.3 | 60.0 | 57.4 |
| | distribution | Surface hardness | 68.0 | 65.3 | 77.9 | 76.6 | 76.4 | 76.7 | 75.5 |
| | (JIS-C) | Surface hardness − | 11.2 | 11.6 | 17.2 | 16.7 | 18.1 | 16.7 | 18.1 |
| | | Center hardness | | | | | | | |

| | | | | | | | |
|---|---|---|---|---|---|---|---|
| Productivity | NG | NG | good | good | good | Exc | Exc |

Details on the ingredients mentioned in the table are given below.
Polybutadiene rubber: Available under the trade name “BR01” from JSR Corporation.
Zinc oxide: Available as “Zinc Oxide Grade 3” from Sakai Chemical Co., Ltd.
Barium sulfate: Available under the trade name “Barico #100” from Hakusui Tech
Antioxidant: Available under the trade name “Nocrac NS-6” from Ouchi Shinko Chemical Industry Co., Ltd.
Zinc salt of pentachlorothiophenol: Available from Wako Pure Chemical Industries, Ltd.
Unsaturated metal carboxylate: Zinc acrylate (Wako Pure Chemical Industries, Ltd.)
Metal carboxylate 1: Zinc monostearate monoacrylate (Nippon Shokubai Co., Ltd.)
Metal carboxylate 2: Zinc stearate (Wako Pure Chemical Industries, Ltd.)
Organic peroxide 1: Available under the trade name “Percumyl D” from NOF Corporation
Organic peroxide 2: Available under the trade name “Perhexa C-40” from NOF Corporation

The core center hardness (center/cross-section), deflection and initial velocity were measured for the spherical molded and crosslinked core materials obtained in the respective Examples. The results are presented in Table 1.

### Core Deflection

The amount of deflection by a core when placed on a hard plate and compressed under a final load of 1,275 N (130 kgf) from an initial load state of 98 N (10 kgf) was measured for each core. The amount of deflection here refers in each case to the measured value obtained after holding the core isothermally at 23.9° C.

### Center and Surface Hardnesses of Core (JIS-C Hardness)

The core center hardness was obtained by cutting the spherical core in half through the center and measuring the hardness at the center of the resulting cross-section. The core surface hardness was obtained by perpendicularly pressing the indenter of a durometer against the surface of the spherical core and measuring the hardness. The JIS-C hardness is measured with the spring-type durometer (JIS-C model) specified in JIS K 6301-1975. The average value for three cores was determined, and this average value was treated as the measured value. The above hardnesses are all measured values obtained after holding the core isothermally at 23° C.

### Initial Velocity of Core

The initial velocity of the core was measured using an initial velocity measuring apparatus of the same type as the USGA drum rotation-type initial velocity instrument approved by the R&A. The core was temperature-conditioned for at least 3 hours at a temperature of 23±1° C., and then tested in a chamber at a room temperature of 23±2° C. The average value was determined for ten cores, and this average was treated as the measured value.

The core productivity for each Example was evaluated according to the following criteria. The results are presented in Table 1.

### Productivity

During mixing and extrusion of the rubber composition, the following were evaluated: (i) mixing time, (ii) sticking to inner wall of mixing apparatus, (iii) residues, (iv) coherence of rubber composition following mixture, and (v) surface roughness of rubber composition when extruded. These were judged collectively as being indicative of very high productivity (Exc), high productivity (Good), or low productivity (NG).

As is apparent from the results in Table 1, the productivity in Working Examples 1 to 7 was higher than in Comparative Examples 1 and 2. Also, in Working Examples 1 to 7, even when the metal carboxylate content was the same as in Comparative Examples 3 to 7, the initial velocity of the core was higher and a comparable productivity was maintained.

Japanese Patent Application No. 2016-231567 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A golf ball comprising, as a structural element therein, a molded and crosslinked material obtained from a rubber composition, comprising:
(a) a base rubber,
(b) an α,β-unsaturated carboxylic acid and/or a metal salt thereof,
(c) a crosslinking initiator, and
(d) a metal carboxylate in which the carboxylic acid bonded to metal is of two or more different types and at least one of the carboxylic acids has 8 or more carbon atoms.

2. The golf ball of claim 1, wherein component (b) is a metal salt of an α,β-unsaturated carboxylic acid.

3. The golf ball of claim 2, wherein the unsaturated metal carboxylate serving as component (b) is a zinc salt.

4. The golf ball of claim 1, wherein the content of component (b) is from 5 to 50 parts by weight per 100 parts by weight of component (a).

5. The golf ball of claim 1, wherein at least one of the carboxylic acids bonded to metal in the metal carboxylate serving as component (d) is an unsaturated carboxylic acid.

6. The golf ball of claim 5, wherein the unsaturated carboxylic acid is an α,β-unsaturated carboxylic acid having from 3 to 8 carbon atoms.

7. The golf ball of claim 1, wherein the metal species in the metal carboxylate serving as component (d) is selected from the group consisting of zinc, calcium, magnesium, copper, aluminum, iron and zirconium.

8. The golf ball of claim 1, wherein the content of component (d) is from 1 to 25 parts by weight per 100 parts by weight of component (a).

9. The golf ball of claim 1, wherein component (d) has a weight ratio with respect to component (b) of from 4 to 50 wt %.
